(19) United States
(12) Patent Application Publication
(10) Pub. No.: US 2023/0415993 A1
(43) Pub. Date: Dec. 28, 2023

(54) REMOTELY OPERATED PICKING VEHICLE

(71) Applicant: Autostore Technology AS, Nedre Vats (NO)

(72) Inventor: Jørgen Djuve Heggebø, Olen (NO)

(73) Assignee: Autostore Technology AS, Nedre Vats (NO)

(21) Appl. No.: 18/253,978

(22) PCT Filed: Nov. 16, 2021
(86) PCT No.: PCT/EP2021/081819

§ 371 Date: May 23, 2023

(30) Foreign Application Priority Data
Nov. 30, 2020 (NO) 20201316

(51) Int. Cl. B65G 1/04; B65G 1/137

(52) U.S. Cl. CPC B65G 1/0492; B65G 1/1375

(57) ABSTRACT

A remotely operated picking vehicle, which is for an automated storage and retrieval system for retrieving and storing products within storage containers, includes a vehicle body, a picker support, and a storage container. The vehicle body includes a base with displacement means for transportation on a rail system. The picker support, which is for a robotic picking device or a human picker, is arranged on the vehicle body. The storage container magazine, which is for supporting three or more storage containers simultaneously, is arranged on the vehicle body. The storage container includes a storage container loading/offloading position and a storage container accessing position. The storage container loading/offloading position is for loading and offloading of storage containers by means of a container handling vehicle. The storage container accessing position is for presenting storage containers to a picker positioned on the picker support.

### FIELD OF THE INVENTION

The present invention relates to an automated storage and retrieval system for storage and retrieval of containers, in particular to a remotely operated vehicle for an automated storage and retrieval system.

### BACKGROUND AND PRIOR ART

FIG. 1 discloses a typical prior art automated storage and retrieval system 1 with a framework structure 100 and FIGS. 2 and 3 disclose two different prior art container handling vehicles 201,301 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked one on top of one another to form stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301 are operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301 in a first direction X across the top of the frame structure 100, and a second set of parallel rails 111 arranged perpendicular to the first set of rails 110 to guide movement of the container handling vehicles 201,301 in a second direction Y which is perpendicular to the first direction X. Containers 106 stored in the columns 105 are accessed by the container handling vehicles through access openings 112 in the rail system 108. The container handling vehicles 201,301 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301 comprises a vehicle body 201a,301a, and first and second sets of wheels 201b,301b,201c,301c which enable the lateral movement of the container handling vehicles 201,301 in the X direction and in the Y direction, respectively. In FIGS. 2 and 3 two wheels in each set are fully visible. The first set of wheels 201b,301b is arranged to engage with two adjacent rails of the first set 110 of rails, and the second set of wheels 201c,301c is arranged to engage with two adjacent rails of the second set 111 of rails. At least one of the sets of wheels 201b,301b,201c,301c can be lifted and lowered, so that the first set of wheels 201b,301b and/or the second set of wheels 201c,301c can be engaged with the respective set of rails 110, 111 at any one time.

Each prior art container handling vehicle 201,301 also comprises a lifting device (not shown) for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301 so that the position of the gripping/engaging devices with respect to the vehicle 201,301 can be adjusted in a third direction Z which is orthogonal the first direction X and the second direction Y. Parts of the gripping device of the container handling vehicle 301 are shown in FIG. 3 indicated with reference number 304. The gripping device of the container handling device 201 is located within the vehicle body 301a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane P_{H}. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201,301 can be said to travel in layer Z=0, and each storage column 105 can be identified by its X and Y coordinates.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y and Z-direction.

Each prior art container handling vehicle 201,301 comprises a storage compartment or space for receiving and stowing a storage container 106 when transporting the storage container 106 across the rail system 108. The storage space may comprise a cavity arranged centrally within the vehicle body 201a as shown in FIG. 2 and as described in e.g. WO2015/193278A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 101 may have a footprint which is larger than the lateral area defined by a storage column 105, e.g. as is disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles.

Alternatively, or in addition, the automated storage and retrieval system 1 may have container handling vehicles 201,301 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301 so that a desired storage container 106 can be delivered to the desired location at the desired time without the container handling vehicles 201,301 colliding with each other, the automated storage and retrieval system 1 comprises a control system 500 which typically is computerized and which typically comprises a database for keeping track of the storage containers 106.

FIG. 4 shows examples of product items 80 stored in a storage container 106 having height H_{f}, a width W_{f} and a length L_{f}. The storage container 106 has a horizontal cross section Af.

Prior art includes WO2019/238641A1, which discloses a picking system where items are retrieved from, and replaced into, storage containers by use of a robotic operator located at an access station near the lower end of port columns. The robotic operator has a working area limited by the length of a robotic arm.

Transporting storage containers one-by-one between storage cells and to dedicated port columns located at the peripherals of the storage grid and to transport these storage containers down to an access station for further handling of items stored within the containers takes time. Traffic congestion of container handling vehicles may also represent an important cause of low efficiency. These disadvantages will be particularly evident when operating large storage systems, for examples storage grids of 700×700 storage cells or larger.

It is therefore an objective of the invention to provide a picking system that may increase the through-put rate of items compared to prior art systems.

Another objective of the invention is to provide a picking system that enables the robotic operator to pick more items within its working area compared to prior art systems.

### SUMMARY OF THE INVENTION

The present invention is set forth and characterized in the independent claims, while the dependent claims describe other characteristics of the invention.

The present invention relates to a remotely operated picking vehicle for an automated storage and retrieval system for retrieving and storing products within storage containers, wherein the remotely operated picking vehicle comprises:
a vehicle body comprising a base with displacement means for transportation on a rail system;
a picker support for a robotic picking device or a human picker, the picker support being arranged on the vehicle body;
a storage container magazine for supporting three or more storage containers simultaneously, the storage container magazine being arranged on the vehicle body and comprising:
a storage container loading/offloading position for loading and offloading of storage containers by means of a container handling vehicle; and
a storage container accessing position for presenting storage containers to a picker positioned on the picker support.

A container delivery vehicle may alternatively be used instead of the container handling vehicle. Alternatively, container handling vehicles and container delivery vehicles may be used in combination. Alternatively, any other suitable vehicle or device may be used instead of the container handling vehicle.

The storage container loading/offloading position and the storage container accessing position does not need to be exact positions. The storage container loading/offloading position and the storage container accessing position may be defined by areas in which a storage container, supported by the storage container magazine, can be located. The storage container loading/offloading position and the storage container accessing position may be the same position or defined by the same area. In other cases, the storage container loading/offloading position and the storage container accessing position may be completely separated or at least partly separated.

The accessing position is a position or an area of the storage container magazine in which storage containers are positioned to provide a robotic picking device or a human picker located on the picker support access to the inner volume of the storage container.

A product may be picked from a storage container located in the accessing position when the remotely operated picking vehicle is stationary or while the remotely operated picking vehicle is moving around on the rail system.

The loading/offloading position is a position or an area of the storage container magazine configured for loading/offloading of storage containers, in particular by means of one or several container handling vehicles.

A storage container may be loaded or offloaded the loading/offloading position when the remotely operated picking vehicle is stationary or while the remotely operated picking vehicle is moving around on the rail system.

The remotely operated picking vehicle can move around on top of the storage system. One or several container handling vehicles can exchange storage containers with the remotely operated picking vehicle arranged on the same level, instead of delivering the storage containers to a port arranged on the ground level. The capacity of the port columns may thus be less of a bottle neck in the system. The remotely operated picking vehicle can move to a position closer to where the target storage container is located in the storage system to reduce the travel distance for the container handling vehicles supplying storage containers to the remotely operated picking vehicle. Based on the items to be picked, the control system can plan the most efficient route for the remotely operated picking vehicle and the at least one container handling vehicle supplying it with storage containers.

An advantage of operating on top of the storage system, is that the distance between the robotic or human picker and the target storage containers is reduced.

With the remotely operated picking vehicle a continuous picking process can be achieved where subsequent storage containers are immediately available to the robotic picking device or the human picker.

An advantage of the remotely operated picking vehicle is thus that the order picking efficiency can be increased.

A further advantage of the remotely operated picking vehicle is that it reduces the risk of congestion of container handling vehicles in the area surrounding the port columns.

In addition to the storage containers being picked from, the storage container handling device may also handle a consolidation bin that products are picked to.

The consolidation bin can be moved by the storage container handling device together with the storage containers as they are shifted from the storage container accessing position to the storage container loading/offloading position, and vice versa. The consolidation bin may then be move into the storage container accessing position for the robotic or human picker to place products in it.

Alternatively, the consolidation bin may be stationary when the storage containers are moved by the storage container handling device. The consolidation bin can then be positioned outside the storage container accessing position and still within reach of the robotic picking device or human picker such that products can be placed in it.

The consolidation bin may e.g. be a packaging box or a container similar to the storage containers.

The storage container handling device may be configured with the storage container loading/offloading position located inside the footprint of the vehicle body. The storage container handling device may alternatively be configured with the storage container loading/offloading position located outside the footprint of the vehicle body.

The container handling vehicle is typically a separate vehicle not part of the remotely operated picking vehicle.

In one aspect, the remotely operated picking vehicle may be configured to be pushed or pulled around the rail system by means of another vehicle.

In one aspect, the displacement means may comprise:
a first set of wheels, arranged on opposite sides of the base, for moving the remotely operated picking vehicle along a first horizontal direction on the rail system; and
a second set of wheels, arranged on other opposite sides of the base, for moving the remotely operated picking vehicle along a second horizontal direction on the rail system, the second direction being perpendicular to the first direction.

In one aspect, the displacement means may comprise:
a set of continuous tracks, arranged on opposite sides of the base, for moving the remotely operated picking vehicle on the rail system.

In one aspect, the vehicle body may comprise:
a propulsion device, such as a motor, configured to operate the displacement means.

In one aspect, the storage container magazine may comprise a container handling device configured for movement of a storage container at least from a storage container loading/offloading position to a storage container accessing position.

The movement between the storage container loading/offloading position and the accessing position may primarily be in a horizontal direction.

The storage container handling device may preferably configured to be in signal communication with a control system.

In one aspect, the storage container magazine may comprise a plurality of storage container handling devices arranged adjacent the picker support.

The plurality of storage container handling devices may be of the same type or different types.

By comprising a plurality of storage container handling devices, a greater number of container handling vehicles may supply storage containers to the remotely operated picking vehicle and thus increase the through put of storage containers.

By comprising a plurality of storage container handling devices, a plurality of storage containers can be in the storage container accessing position simultaneously. This may increase the picking efficiency.

In one aspect, the picker support may be configured for horizontal movement of the robotic picking device or the human picker.

In one aspect, the base may have a footprint and the storage container accessing position is horizontally arranged inside the footprint.

In one aspect, the remotely operated picking vehicle may comprise a plurality of storage container loading/offloading positions.

The remotely operated picking vehicle may pick products from a storage container located in the storage container accessing position while at the same time another storage container is supplied at a first storage container loading/offloading position.

At the same time a further storage container can be retrieved at a second storage container loading/offloading position.

Storage containers may thus be provided at a first storage container loading/offloading position and then retrieved from a second storage container loading/offloading position, after being picked.

Alternatively, a storage container may be provided and subsequently retrieved from the first storage container loading/offloading position, while another storage container is provided and subsequently retrieved from the second storage container loading/offloading position.

The storage container handling vehicles may choose a storage container loading/offloading position based on the traffic around the remotely operated picking vehicle. If one side of the remotely operated vehicle is busier than the other, the storage container handling vehicles may choose the least busy side to provide and/or retrieve storage containers from.

In one aspect, the remotely operated picking vehicle may comprise a plurality of storage container accessing positions.

While a product is picked from a storage container located in a first accessing position, another storage container containing a product to be picked can be provided at a second accessing position. While the product is picked from the storage container located at the second accessing position, yet another storage container containing a product to be picked can be provided at the first accessing position. By providing even further accessing positions the picking efficiency may be further improved.

A storage container loading/offloading position located within reach of the robotic picking device or human picker may also be used as a storage container accessing position.

A storage container accessing position located within reach of the storage container handling vehicle may also be used as a storage container loading/offloading position.

In one aspect, the storage container handling device may comprise:
a rotational carousel device having a rotational axis; and
a plurality of storage container supports connected to the rotational carousel device, allowing rotation of the storage container supports through at least a storage container loading/offloading position and a storage container accessing position.

The storage container supports may be distributed around the rotational carousel device with fixed angular spacings. Typically, evenly distributed around the rotational carousel device. Alternatively, the storage container supports may rotate relative to the rotational carousel device independently of each other.

In one aspect, the storage container handling device may further comprise:
a carousel arm extending radially from a central portion of the rotational carousel device; and
a carousel motor configured to rotate the carousel arm around the vertical rotational axis;
wherein the storage container support is arranged at an end of the carousel arm distal to the vertical rotational axis.

The storage container handling device may comprise a corresponding number of carousel arms and storage container supports.

One carousel arm is typically connected to one storage container support.

Alternatively, one carousel arm may be connected to two storage container supports, e.g. by being wishbone shaped.

Alternatively, one carousel arm may be configured for connection to a plurality of storage container supports, e.g. by having a length exceeding the combined width or length of the number of storage containers to be supported by that carousel arm. In that way one or several storage containers can be connected to the carousel arm between the carousel device and the distal end of the carousel arm.

The carousel arms of the container handling device may have the same length.

The storage container supports may be arranged with a radial distance between the rotational axis of the rotational carousel device and a horizontal centre point of the storage container support.

In one aspect, the carousel arm may have hinged connections to the container support and to the rotational carousel device.

The hinged connection is typically vertically oriented to allow the storage container supports to be adjusted in the vertical direction. The storage container supports may thus be vertically aligned while kept level. All the storage container supports may simultaneously be horizontally positioned within the footprint of the vehicle body.

The storage container magazine may thus provide a vertical stack of storage containers waiting to be picked from or picked to.

The storage container support may thus allow different vertical elevations of the storage container loading/offloading position and the storage container accessing position, particularly when the storage container loading/offloading position is located outside the footprint of the vehicle body.

In one aspect, the storage container handling device may comprise:
a conveyor or rollers for horizontal movement of a storage container through at least the storage container loading/offloading position and the storage container accessing position.

The conveyor or rollers may be arranged to extend the entire horizontal length or width of the vehicle body. The conveyor or rollers may then typically have an input side where storage containers enter and an output side where storage containers exit and therebetween the storage container accessing position. The storage container handling device may be configured with storage container loading/offloading positions at the input side and/or at the exit side of the conveyor or rollers.

Two or more conveyors or rows of rollers may be arranged in parallel on the same vehicle body. If several conveyors or rows of rollers are used, the picker support may be arranged in the middle.

The rollers or conveyor may have a portion extending outside the footprint of the vehicle body.

In one aspect, the storage container handling device may comprise a slider for translating the storage containers. E.g. the slider may be a drawer slide.

In one aspect, the storage container handling device may comprise wheeled platforms for shuffling the storage containers around the base of the remotely operated picking vehicle. E.g. the wheeled platforms may be robotic devices such as drones.

In one aspect, the storage container magazine may comprise a fixed storage container support.

The fixed storage container support may be foldable to reduce the footprint of the remotely operated picking vehicle when the fixed storage container is not used to support a storage container or similar.

The consolidation bin or a pallet supporting a plurality of consolidation bins can typically be placed on the fixed storage container support. A pallet may be provided and retrieved by means of a forklift or other pallet handling vehicles.

A storage container containing high-demand products can typically be placed on the fixed storage container support.

The fixed storage container support is preferably arranged within reach of the robotic picking device or the human picker.

In one aspect, the picker support may have a portion that extends vertically above the storage container magazine.

The picker support may be an arch arranged on the vehicle body. The robotic picking device may be arranged upside-down inside the arch. The footprint of the remotely operated picking vehicle can thus be reduced.

Alternatively, the robotic picking device may be arranged on a vertical side surface of the arch or the wheeled base.

In one aspect, the remotely operated vehicle may further comprise:
a robotic picking device, wherein the robotic picking device comprises:
a first robotic segment connected to the vehicle body; and
a gripper connected at least indirectly to the first robotic segment, the gripper being spaced at an adjustable radial gripper distance between the first robotic segment and the gripper such that the gripper is at least within reach of the storage container accessing position,
   wherein the gripper is configured to releasably grab a product from within a storage container positioned in the storage container accessing position; and
   wherein the robotic picking device is configured to be in signal communication with a control system.

In one aspect, the first robotic segment may be rotatably connected to the vehicle body with a first rotational axis.

In one aspect, the robotic picking device may further comprise:
a second robotic segment rotatably connected to the first robotic segment, wherein a longitudinal orientation of the second robotic segment is adjustable relative to the first rotational axis.

In one aspect, the second robotic segment may comprise:
a first end rotatably connected to the first robotic segment; and
   wherein the robotic picking device may further comprise:
a third robotic segment comprising a first end rotatably connected to a second end of the second robotic segment and a second end at least indirectly connected to the gripper.

In one aspect, the robotic picking device may have a radial gripper distance extending outside the footprint, wherein the gripper is configured to releasably grab a product from within a storage container positioned below the rail system.

In one aspect, the remotely operated picking vehicle may further comprise:
a camera system, the camera system comprising:
a camera configured to visually inspect products within a storage container positioned in, or approaching, the storage container accessing position; and
a camera transmitter configured to transmit information from the visual inspection of the contents to the control system.

The camera system may be a rotatable camera system rotatably arranged on the remotely operated picking vehicle. The rotatable camera system may comprise a camera base arranged above the rotatable container carousel and a camera rotatably connected to the camera base. The rotatable camera system may be configured such that the camera can visually inspect contents within a storage container when the storage container support is oriented in, or approaching, a picking position.

The rotatable camera system may further comprise a camera arm rotationally coupled at one longitudinal position to the camera base, wherein the camera is coupled to the camera arm at another longitudinal position.

The present invention also relates to an automated storage and retrieval system, wherein the automated storage and retrieval system comprises:
a remotely operated picking vehicle according to any one of the preceding claims;
a rail system comprising a first set of parallel rails arranged in a horizontal plane and extending in a first direction and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighbouring rails of the first set of rails and a pair of neighbouring rails of the second set of rails;
a plurality of stacks of storage containers arranged in storage columns located beneath a storage section of the rail system, wherein each storage column is located vertically below a grid opening; and
a container handling vehicle comprising a lifting device for lifting storage containers stacked in the stacks above the storage section and drive means configured to drive the vehicle along the rail system in at least one of the first direction and the second direction.

The present invention also relates to a method of handling products within storage containers stored in an automated storage and retrieval system as described herein, wherein the method comprises the steps of:
placing a storage container in a storage container magazine of a remotely operated picking vehicle by means of a storage container handling vehicle;
picking a product from the storage container by means of a robotic picking device or a human picker; and
retrieving the storage container from the storage container magazine by means of the storage container handling vehicle.

In one aspect, the remotely operated picking vehicle may comprise a storage container handling device, and the storage container accessing position may have a different location than the storage container loading/offloading position, wherein the method may further comprise the steps of:
before a product is picked, moving the storage container from the storage container loading/offloading position to a storage container accessing position by means of a storage container handling device; and
after a product is picked, moving the storage container from the storage container accessing position to the storage container loading/offloading position by means of the storage container handling device.

In one aspect, the method may further comprise the step of:
placing the picked product in a consolidation bin supported by the storage container handling device.

In one aspect, the method may further comprise the step of:
moving the remotely operated picking vehicle along the rail system in a direction of a target storage container.

In one aspect, the remotely operated picking vehicle may comprise a plurality of loading/offloading positions,

wherein the method further comprises the step of:
while retrieving one storage container from a first storage container loading/offloading position by means of a first storage container handling vehicle, providing another storage container at a second storage container loading/offloading position by means of a second storage container handling vehicle.

The retrieving and providing may be performed simultaneously or in succession.

The retrieving and providing may be performed simultaneously while the robotic picking device or the human picker is putting a product in the consolidation bin.

Between the retrieving and providing, if performed in succession, the robotic picking device or the human picker may put a product in the consolidation bin.

Thus, the storage container handling vehicle providing one storage container does not have to wait for the other storage container handling vehicle retrieving another storage container to move out of the way. The waiting time for the container handling vehicles can thus be reduced and the picking efficiency improved.

In one aspect, the remotely operated picking vehicle may comprise a plurality of storage container accessing positions,

wherein the method further comprises the step of:
with a first storage container positioned in a first storage container accessing position, providing a second storage container in a second storage container accessing position.

Yet another storage container may subsequently be moved from the storage container loading/offloading position to the first storage container accessing position or alternatively to a third storage container accessing position.

The storage containers may be moved from the same storage container loading/offloading position or from different storage container loading/offloading positions.

The robotic picking device or human picker may then not have to pick from the same storage container accessing position two times in a row. In this way, a subsequent storage container may always be available to the robotic picking device or human picker. As the robotic picking device or human picker does not have to wait for a subsequent storage container to pick from, there may be no waiting time for the robotic picking device or human picker and the picking efficiency can thus be improved.

The remotely operated picking vehicle can be adapted to the automated storage and retrieval system e.g. based on the size of the system or the throughput of the system.

High throughput systems may benefit from a higher number of storage container accessing positions and/or a higher number of storage container loading/offloading positions. Queues of container handling vehicles congesting the area around the remotely operated picking vehicle can thus be avoided.

The remotely operated picking vehicle can be adapted to the automated storage and retrieval system by means of the number and type of storage container handling devices. The remotely operated picking vehicle may have one or several storage container handling devices of the same type. The remotely operated picking vehicle may have several storage container handling devices of different types.

The number of remotely operated picking vehicles operating in the same automated storage and retrieval system may also be adapted. A greater number of remotely operated picking vehicles will improve the flexibility of the system.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having a centrally arranged cavity for carrying storage containers therein;

FIG. 3 is a perspective view of a prior art container handling vehicle having a cantilever for carrying storage containers underneath;

FIG. 4 is a perspective view of a storage container and product items stored in the storage container;

FIG. 5 is a perspective view of a remotely operated picking vehicle comprising a storage container magazine for supporting four storage containers simultaneously;

FIG. 6 is a perspective view of the remotely operated picking vehicle wherein the storage container magazine comprises a storage container handling device in the form of a rotational carousel device for supporting three storage containers that can be rotated between at least an accessing position and a loading/offloading position;

FIG. 7a is a perspective view of the remotely operated picking vehicle wherein the storage container magazine comprises a storage container handling device in the form of a rotational carousel device and a fixed storage container support;

FIG. 7b is a perspective view of the remotely operated picking vehicle of FIG. 7a wherein the fixed storage container support has been folded up;

FIG. 8 is a perspective view of the remotely operated picking vehicle wherein the storage container magazine comprises a storage container handling device in the form of a rotational carousel device for supporting three storage containers, all of which have been arranged in a vertical stack;

FIG. 9 is a top view of the remotely operated picking vehicle wherein the storage container magazine comprises a plurality of storage container handling devices in the form of rotational carousel devices and a robotic picking device is arranged on the picker support;

FIG. 10 is a perspective view of the remotely operated picking vehicle of FIG. 9;

FIG. 11 is a perspective view of the remotely operated picking vehicle of FIG. 9 wherein the storage container supports of each storage container handling device have been arranged in vertical stacks;

FIG. 12 is a perspective view of the remotely operated picking vehicle wherein the storage container magazine comprises two storage container handling devices in the form of conveyors each for supporting three storage containers that can be displaced between at least an accessing position and a loading/offloading position;

FIG. 13 is a perspective view of the remotely operated picking vehicle wherein the storage container magazine comprises two storage container handling devices, one in the form of a conveyor and one in the form of rollers for supporting two storage containers that can be displaced between at least an accessing position and a loading/offloading position;

FIG. 14 is a perspective view of the remotely operated picking vehicle and a storage container handling vehicle loading a storage container on the loading/offloading position of the storage container magazine;

FIG. 15 is a perspective view of the remotely operated picking vehicle wherein the picker support has a portion that extends vertically above the storage container magazine;

FIG. 16a is a perspective view of the remotely operated picking vehicle wherein the storage container magazine comprises a storage container handling device in the form of a conveyor; and

FIG. 16b is a perspective view of the remotely operated picking vehicle of FIG. 16a, wherein the conveyor has been folded up.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

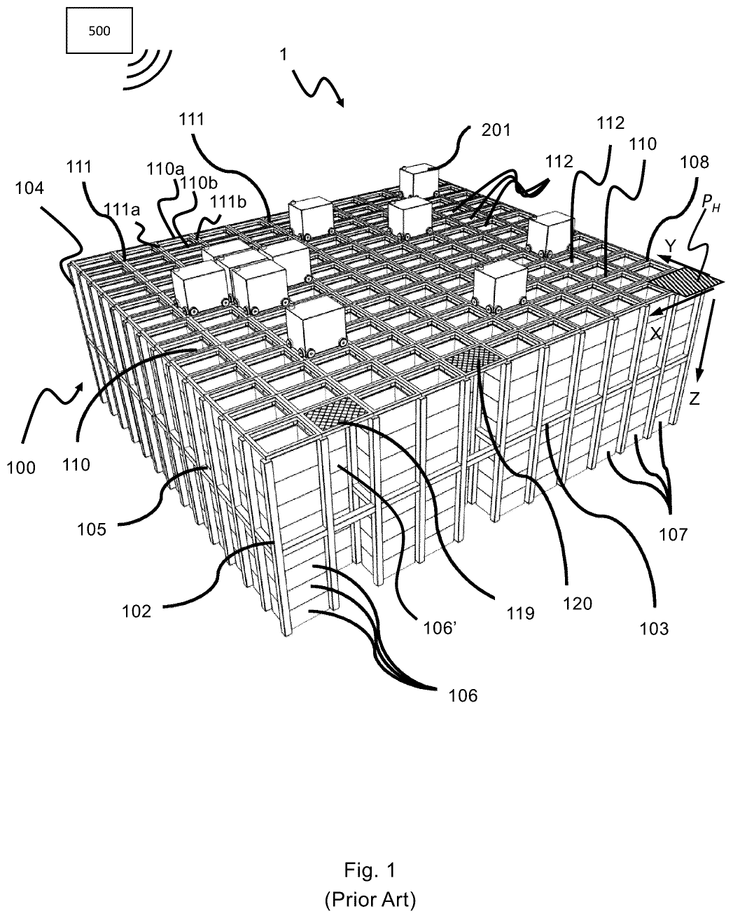

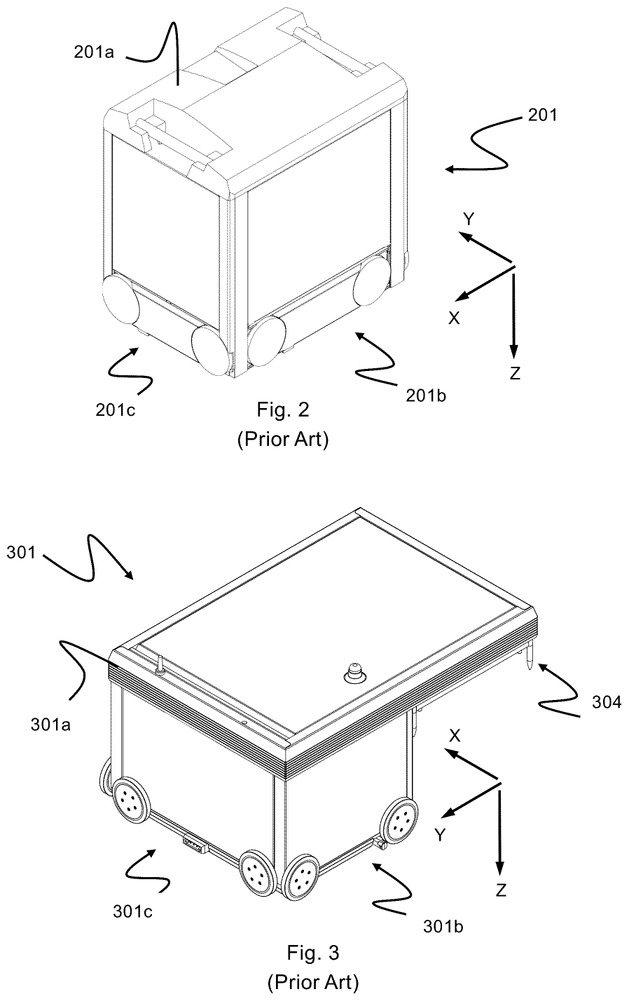

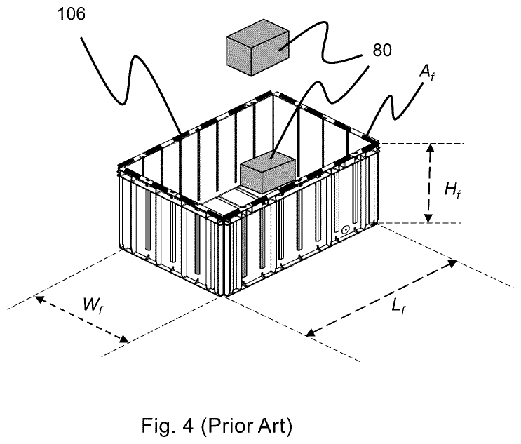

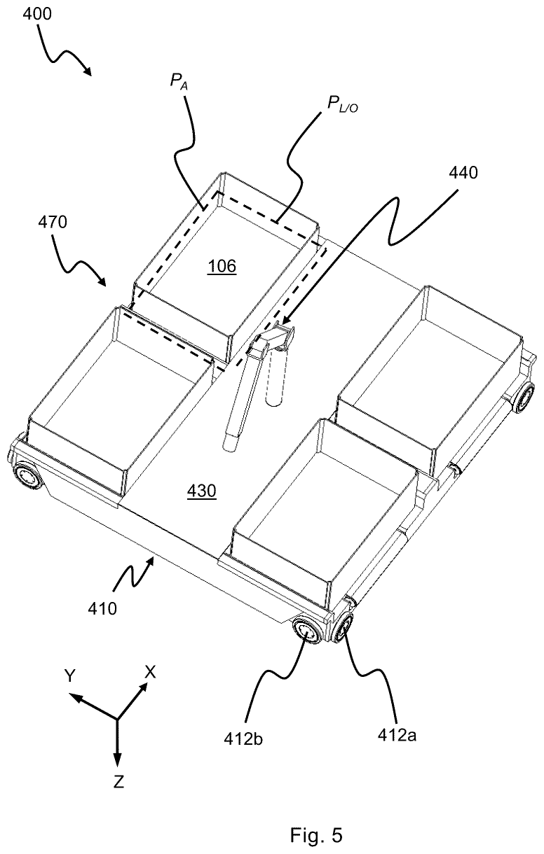

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

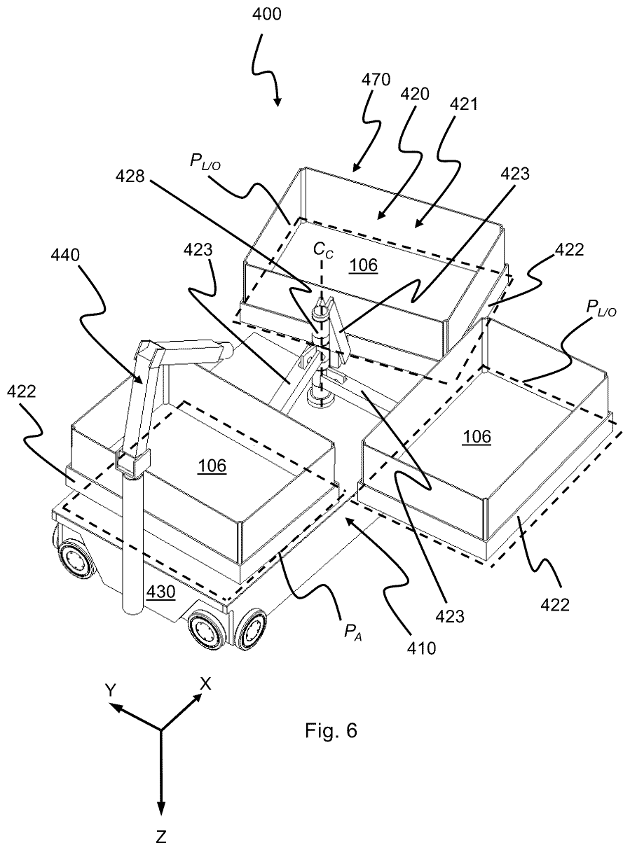

FIG. 5 is a perspective view of a remotely operated picking vehicle 400 for an automated storage and retrieval system 1 for retrieving and storing products 80 within storage containers 106.

The remotely operated picking vehicle 400 comprises a vehicle body 410 having a base 411 with displacement means in the form of a first set of wheels 412a, arranged on opposite sides of the base 411, for moving the remotely operated picking vehicle 400 along a first horizontal direction X on the rail system 108; and a second set of wheels 412b, arranged on other opposite sides of the base 411, for moving the remotely operated picking vehicle 400 along a second horizontal direction Y on the rail system 108, the second direction Y being perpendicular to the first direction X. Alternatively, the displacement means could be a set of continuous tracks, arranged on opposite sides of the base 411, for moving the remotely operated picking vehicle 400 on the rail system 108.

The remotely operated picking vehicle 400 further comprises a picker support 430 arranged on the vehicle body 410. The picker support 430 is configured to support a robotic picking device 440 or a human picker. In FIG. 5 a robotic picking device 440 is illustrated.

The picker support 430 may be configured for horizontal movement of the robotic picking device 440 or the human picker. The picker support 430 of FIG. 5 covers an area allowing movement of the robotic picking device 440 or possibly a human picker, such that the robotic picker 440 may get closer to the different storage container accessing positions P_{A}. Horizontal movement of the robotic picking device 440 or human picker is preferred if all accessing positions P_{A} cannot be reached by the robotic picking device 440 or human picker from one position.

The remotely operated picking vehicle 400 further comprises a storage container magazine 470 arranged on the vehicle body 410 and configured to support three or more storage containers 106 simultaneously. The storage container magazine of FIG. 5 is configured to support four storage containers 106 simultaneously.

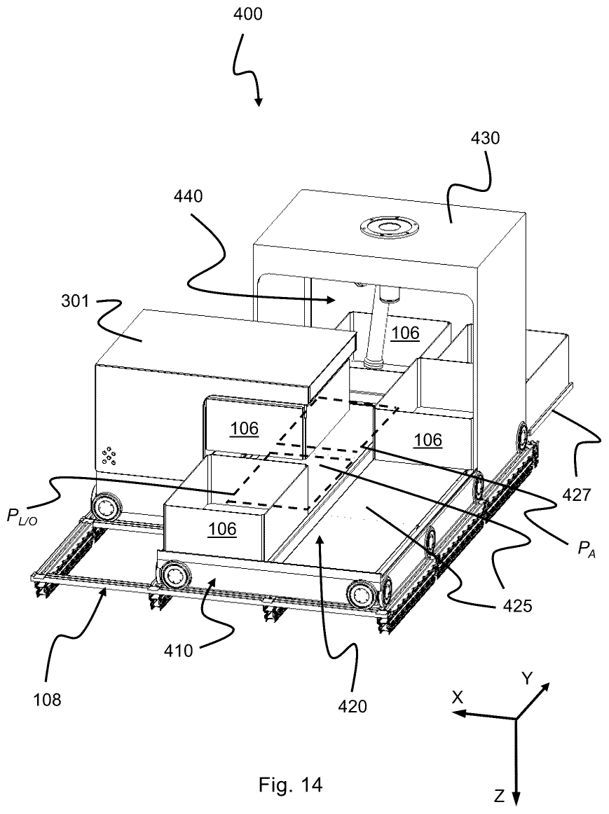

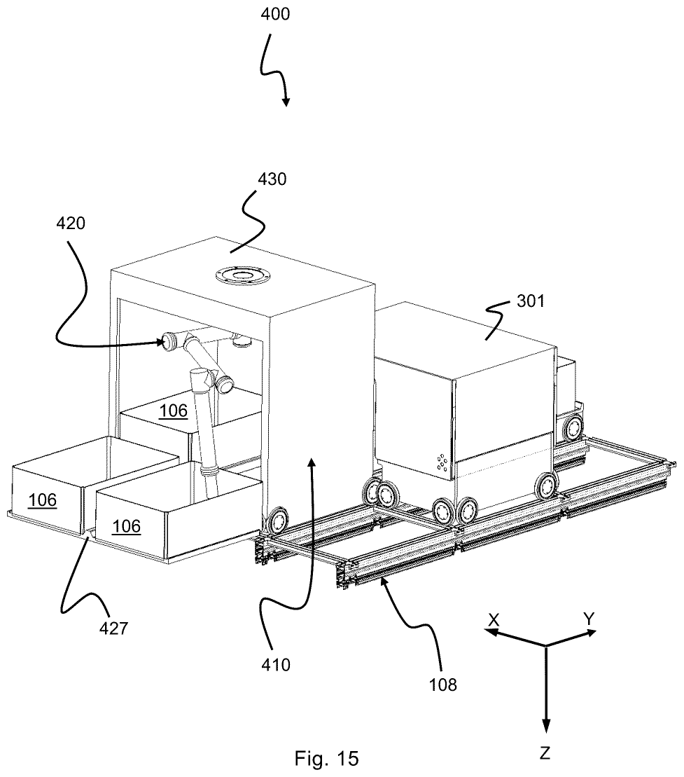

In order to get storage containers 106 in and out of the storage container magazine 470, the storage container magazine 470 comprises at least on storage container loading/offloading position P_{L/O}. The storage container loading/offloading position P_{L/O} is configured for loading and offloading of storage containers 106 by means of a container handling vehicle 301. An example of a container handling vehicle 301 loading/offloading a storage container 106 is illustrated in FIG. 14 and FIG. 15. The remotely operated picking vehicle 400 of FIG. 5 has four storage container loading/offloading positions P_{L/O}.

For a robotic picking device 440 or a human picker positioned on the picker support 430 to be able to pick products 80 from the storage containers 106 in the storage container magazine 470, the storage container magazine 470 comprises at least one storage container accessing position P_{A}. The storage container accessing position P_{A} is configured for presenting storage containers 106 to the robotic picking device 440 or the human picker positioned on the picker support 430. The remotely operated picking vehicle 400 of FIG. 5 has four storage container accessing positions P_{A}.

The storage container loading/offloading positions P_{L/O} of the storage container magazine 470 of FIG. 5 are also configured as storage container accessing position P_{A}, as they are within reach of the robotic picking device 440.

The remotely operated picking vehicle 400 of FIG. 5 is illustrated supporting four storage containers 106. One or several of these can be used as consolidation bins. The robotic picking device 440 can thus pick products 80 from one or several storage containers 106 presented to it and then put the product 80 in the consolidation bin. When a consolidation bin is ready picked it can be collected by a storage container handling vehicle 301 or the remotely operated picking vehicle 400 can move to delivery position and offload the consolidation bin itself.

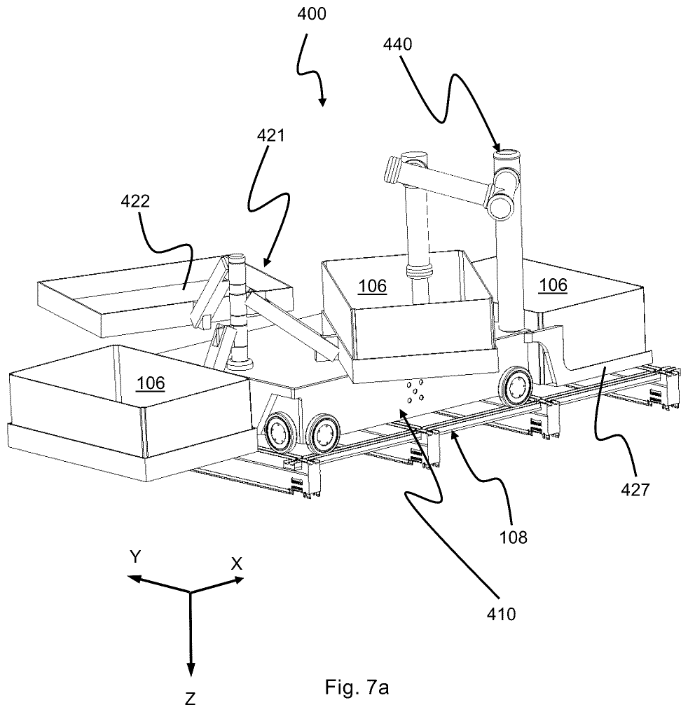

FIG. 6 is a perspective view of the remotely operated picking vehicle 400 wherein the storage container magazine 470 comprises a storage container handling device 420. The storage container handling device 420 is configured for movement of a storage container 106 at least from a storage container loading/offloading position P_{L/O} to a storage container accessing position P_{A} in a horizontal direction. If the storage container accessing position P_{A} is not configured as a storage container loading/offloading position P_{L/O}, the storage container handling device 420 is also configured for movement of a storage container 106 from a storage container accessing position P_{A} to a storage container loading/offloading position P_{L/O}.

The storage container handling device 420 is typically configured to be in signal communication with a control system 500, either directly or indirectly via the remotely operated picking vehicle 400.

The storage container handling device 420 of FIG. 6 is in the form of a rotational carousel device 421 configured to support three storage containers 106. The rotational carousel device 421 is configured to move storage containers 106 between the storage container loading/offloading position P_{L/O} and the storage container accessing position P_{A} in a rotating manner. The rotational carousel device 421 may rotate both clockwise and counterclockwise around a rotational axis C_{C}.

The rotational carousel device 421 may comprise a rotatable shaft 428 having the rotational axis C_{C} as centre axis. The rotational carousel device 421 may further comprise carousel arms 423 extending radially from the rotatable shaft 428. A plurality of storage container supports 422 for supporting storage containers 106 may be connected to the carousel arms 423. As also illustrated in FIG. 6, the carousel arms 423 may have hinged connections 424 to the rotational shaft 428 and the rotational shaft 428.

The rotational carousel device 421 may comprise a carousel motor configured to rotate one or several carousel arms 423 around the vertical rotational axis C_{C}. If one carousel motor is configured to rotate all the carousel arms 423, the carousel arms 423 will typically rotate synchronously. Alternatively, the carousel arms 423 may be provided with one carousel motor each. The carousel arms 423 and thus the storage container supports 422 may be rotated independently.

FIG. 6 illustrates a picker support arranged on a side surface of the vehicle body 410.

In FIG. 6 one of the storage containers 106 is positioned in the accessing position P_{A} in front of the robotic picking device 440. The two other storage containers 106 are positioned in loading/offloading positions P_{L/O}. One of the storage containers 106 may be a consolidation bin. With this configuration and storage container supports 422 rotating independent of each other, one of the container supports 422 may always be available for loading or offloading of a storage container 106.

As an example, a first container handling vehicle 301 carrying a storage container 106 can approach the remotely operated picking vehicle 400, or alternatively the remotely operated picking vehicle 400 can also approach the container handling vehicle 301 carrying the storage container 106. The remotely operated picking vehicle 400 can move a first storage container support 422 into a loading/offloading position P_{L/O}, the first storage container support 422 being empty. The container handling vehicle 301 then place the storage container 106 on the empty storage container support 422. The rotational carousel device 421 can then move the first storage container support 422 into the accessing position P_{A}, such that the robotic picking device 440 can pick a product 80 from the storage container 106. As the first storage container support 422 is moved into the accessing position P_{A}, a second storage container support 422 can be moved into the loading/offloading position P_{L/O}. A second storage container is supported by the second storage container support 422. A product 80 has already been picked from the second storage container 106. The second storage container 106 is thus due to be returned to storage. Without moving, the first container handling vehicle 301 can retrieve the second storage container 106 and take it to storage in the automated storage and retrieval system 1. In the meantime, a second container handling vehicle 301 carrying a third storage container 106 has approached the remotely operated picking vehicle 400. The third storage container 106 can then be placed on the now empty second storage container support 422. The second storage container support 422 is then moved to the accessing position P_{A}. At the same time, the first storage container support 422 is moved into the loading/offloading position P_{L/O}, supporting the second storage container 106 from which a product 80 now has been picked. The second container handling vehicle 301 can then retrieve the second storage container 106 and return it to storage. This cycle can then continue with subsequent container handling vehicles 301. Yet another container handling vehicle 301 can retrieve a consolidation bin supported by a third storage container support 422 when picking of an order is completed.

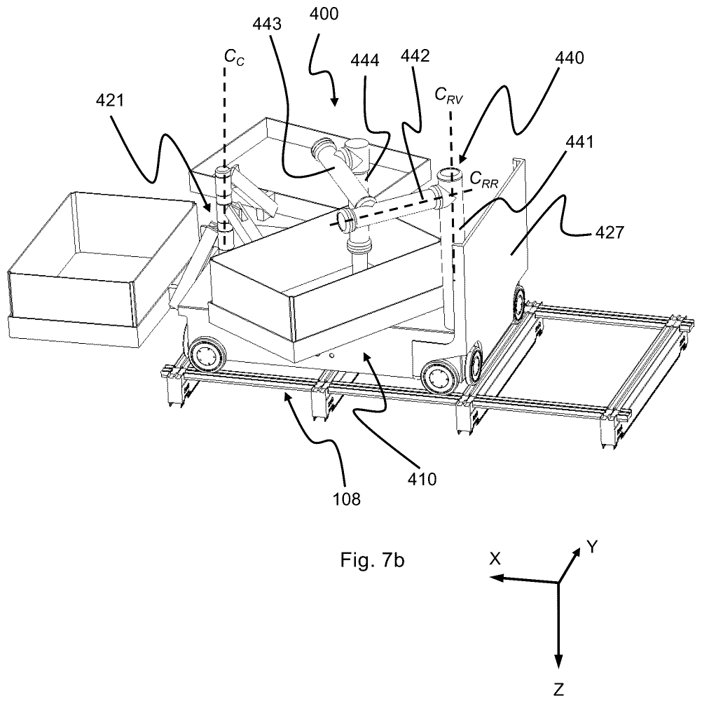

FIG. 7a is a perspective view of the remotely operated picking vehicle 400 wherein the storage container magazine 470 comprises a storage container handling device in the form of a rotational carousel device 421 and a fixed storage container support 427.

FIG. 7b is a perspective view of the remotely operated picking vehicle 400 of FIG. 7a wherein the fixed storage container support 427 has been folded up.

The fixed storage container support 427 is configured to support one storage container 106 in FIG. 7a and FIG. 7b, however, the fixed storage container support 427 may be configured to support a plurality of storage containers 106. One or several storage containers 106 supported by the fixed storage container support 427 may be a consolidation bin.

The fixed storage container support 427 is typically configured to support storage containers 106 in an accessing position P_{A}. The fixed storage container support 427 is preferably configured to support storage containers 106 also in a loading/offloading position P_{L/O}.

By having a consolidation bin on the fixed storage container support 427, all the storage container supports 422 of the rotational carousel device 421 can be used to support storage containers 106 to be picked from.

The remotely operated picking vehicle 400 of FIG. 7a and FIG. 7b is moving along a rail system 108. Due to the hinged connections 424 of the carousel arms 423, the storage container supports 422 can be lowered and elevated. When rotated outside the footprint of the vehicle body F_{VB}, the storage container supports 422 can be lowered closer to the rail system 108 in order to facilitate loading and offloading of storage containers 106.

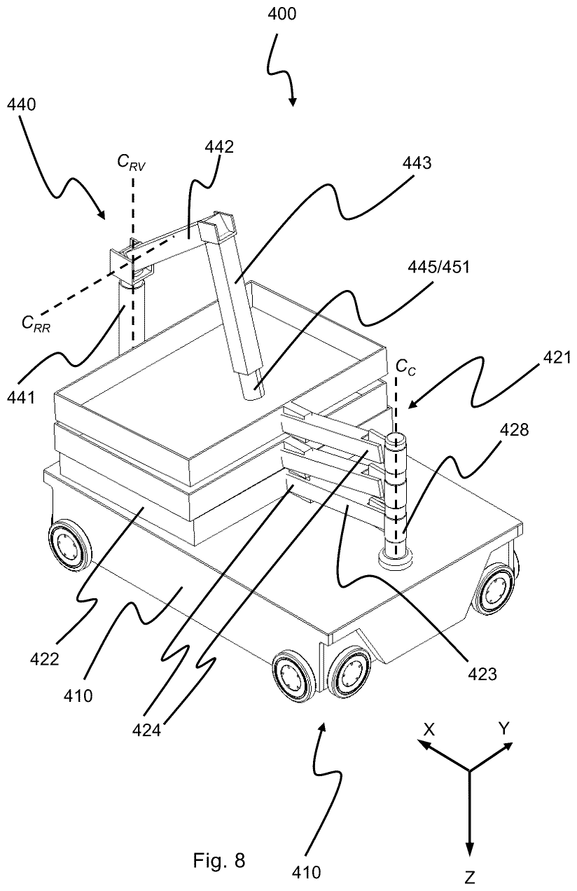

FIG. 8 is a perspective view of the remotely operated picking vehicle 400 wherein the storage container magazine 470 comprises a storage container handling device 420 in the form of a rotational carousel device 421 for supporting three storage containers 106, all of which have been arranged in a vertical stack.

FIG. 8 and FIG. 7b show that the remotely operated picking vehicle 400 may comprise a robotic picking device 440, wherein the robotic picking device 440 comprises a first robotic segment 441 connected to the vehicle body 410. The first robotic segment 441 may be a vertical column. The first robotic segment 441 is preferably rotatably connected to the vehicle body 410 with a first vertical rotational axis C_{RV}.

The robotic picking device 440 further comprises a gripper 445 configured to releasably grab a product 80 from within a storage container 106. The gripper 445 is at least indirectly connected to the first robotic segment 441. The gripper 445 is spaced at an adjustable radial gripper distance R_{G} between the first robotic segment 441 and the gripper 445. The radial gripper distance R_{G} is preferably sufficiently long for the gripper 445 to reach the storage container accessing position P_{A}.

The robotic picking device 440 is typically a multi-joint robotic picking device. The robotic picking device 440 may then further comprise a second robotic segment 442 connected to the first robotic segment 441. The second robotic segment 442 is preferably rotatably connected to the first robotic segment 441 with a first radial rotational axis C_{RR} perpendicular to the first vertical rotational axis C_{RV}, such that a longitudinal orientation of the second robotic segment 442 is adjustable relative to the first vertical rotational axis C_{RV}.

The robotic picking device 440 may further comprise a third robotic segment 443 connected to the second robotic segment 442. The third robotic segment 443 is preferably rotatably connected to the second robotic segment 442 with a third rotational axis. In the example of FIG. 8, the third robotic segment is connected to the gripper 445. In the example of FIG. 7b, the third robotic segment is indirectly connected to the gripper 445 via a fourth robotic segment 444.

The robotic picker 440 is configured such that the gripper 445 may have access to the inside volume of the relevant storage container 106. This may for example be achieved by ensuring that the height of the first robotic segment 441 is at least the height of the storage container support(s) 422 of the rotational carousel device 421.

The remotely operated picking vehicle 400 may comprise a camera system. The camera system typically comprises a camera 451 configured to visually inspect products 80 within a storage container 106 positioned in, or approaching, the storage container accessing position P_{A}. Such a camera 451 may be directly or indirectly connected to one of the robotic segments 441, 442, 443.

The camera system may further comprise a camera transmitter configured to transmit information from the visual inspection of the contents 80 to the control system 500, either directly or indirectly via the robotic picking device 440 or the remotely operated picking vehicle 400.

Note that the number of robotic segments 441, 442, 443 constituting the robotic arm and the direction of rotational axes C_{RV}, C_{RR} may be varied according to the need of accuracy and/or flexibility and/or reach.

The robotic picking device 440 is typically in signal communication with a control system 500, either directly or indirectly via the remotely operated picking vehicle 400.

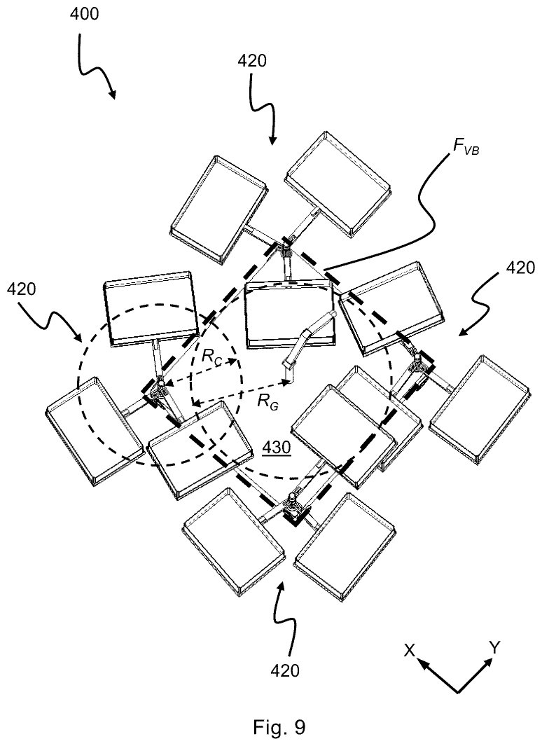

The robotic picking device 440 of FIG. 7b has a radial gripper distance R_{G} extending outside the footprint F_{VB} of the vehicle body. The gripper 445 may then be configured to releasably grab a product 80 from within a storage container 106 positioned below the rail system 108, preferably in an upper layer close to the rail system 108. The radial gripper distance R_{G} is illustrated in FIG. 9.

FIG. 9 is a top view of the remotely operated picking vehicle 400 illustrating that the storage container magazine 470 may comprise a plurality of storage container handling devices 420. In this exemplifying figure the plurality of handling devices 420 are illustrated as four rotational carousel devices 421. The skilled person would understand that the number of storage container handling devices 420 can be increased or reduced. The type of storage container handling devices 420 may also be changed. The plurality of storage container handling devices 420 may be distributed around one or several picker support(s) 430. In this example one picker support 430 is surrounded by storage container handling devices 420, and a robotic picking device 440 is arranged on the picker support 430.

Remotely operated picking vehicles 400 having a storage container magazine 470 comprising a plurality of container handling devices 420 may have a picker support 430 configured to support a plurality of robotic picking devices 440 or a plurality of human pickers.

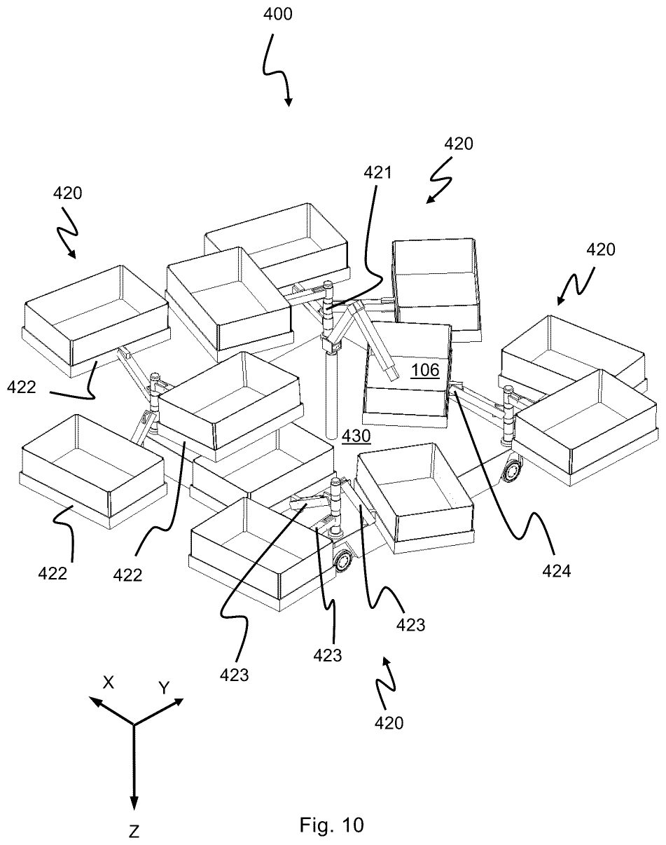

The operation exemplified for FIG. 6 can also be performed with the remotely operated picking vehicle 400 of FIG. 9 and FIG. 10. With a plurality of container handling devices 420 in the form of rotational carousel devices 421, multiple operations can run in parallel.

Each of the storage container supports 422 of the rotational carousel device 421 may be connected to the rotatable shaft 428 at a radial carousel distance R_{C}, i.e. the mid horizontal center of the storage container 106 on each storage container support 422 is located a radial carousel distance R_{C} away from the rotational axis C_{C}. The rotational carousel device 421 is configured such that a rotation of the storage container support(s) 422 around the rotational axis C_{C} follows a circular trajectory with radius equal to the radial carousel distance R_{C}, thus covering a rotational carousel area πR_{C}².

As illustrated in FIG. 9, the robotic picking device 440 is configured such that a rotation of the gripper 445 around the first vertical axis C_{RV} follows a circular trajectory with radius equal to the radial gripper distance R_{G}, thus covering a robotic picking area πR_{G}².

Any given position within an overlap of the robotic picking area and the rotational carousel area is suitable as storage container accessing position(s) P_{A}. The configuration illustrated in FIG. 9 provides four storage container accessing positions P_{A}. This provides the possibility of always having new storage containers 106 to pick from. While the robotic picking device 440 is picking from one storage container 106 in a first accessing position P_{A}, a second storage container 106 can be made available in a second accessing position P_{A}.

As illustrated in FIG. 9, the vehicle body 410 has a footprint F_{VB}. When the radial gripper distance R_{G} does not extend outside this footprint F_{VB}, the storage container accessing position P_{A} will be located within said footprint F_{VB}.

FIG. 10 is a perspective view of the remotely operated picking vehicle 400 of FIG. 9. Due to the hinged connections 424 of the carousel arms 423, the storage container supports 422 can be raised or lowered to have different vertical elevations. This enables a more compact remotely operated picking vehicle 400, as the rotational carousel areas of adjacent rotational carousel devices 421 can overlap.

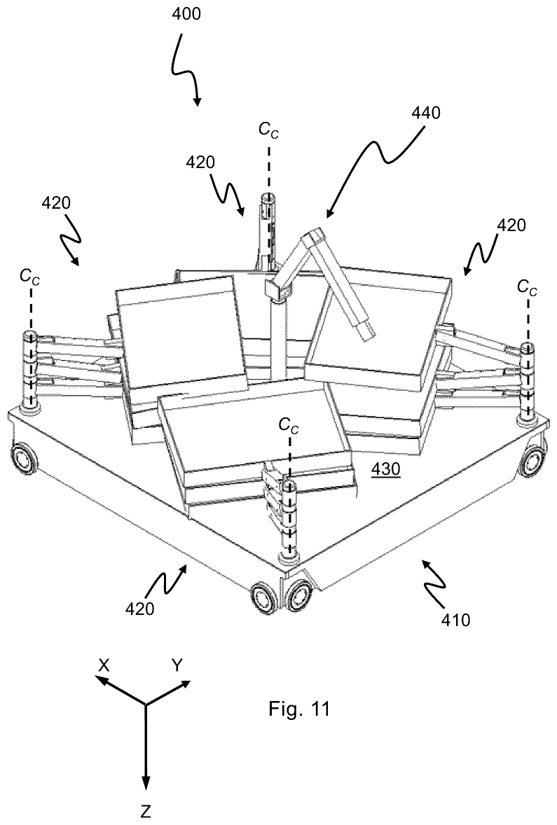

FIG. 11 is a perspective view of the remotely operated picking vehicle 400 of FIG. 9 and FIG. 10 wherein the storage container supports 422 of each storage container handling device 420 have been arranged in vertical stacks within the footprint F_{VB} of the vehicle body 410. It is thus possible to reduce the occupied area of the remotely operated picking vehicle 400 on the rail system 108 when not in use.

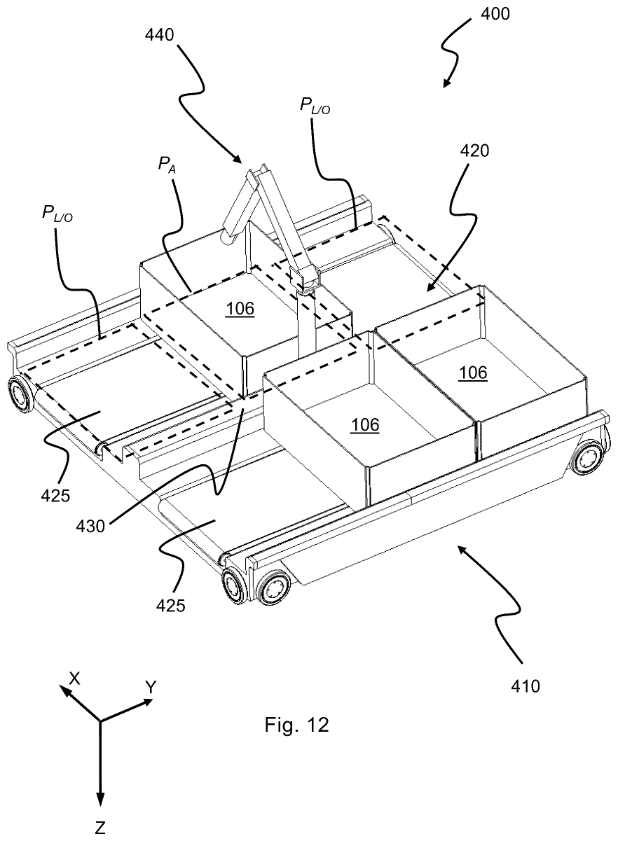

FIG. 12 is a perspective view of the remotely operated picking vehicle 400 wherein the storage container magazine 470 comprises two storage container handling devices 420 in the form of conveyors 425. The conveyor 425 can be configured to support a given number of storage containers 106 in the first direction X and in the second direction Y. In FIG. 12 both conveyors 425 are configured to support one storage container 106 in the first direction X and three storage containers 106 in the second direction Y.

The conveyor 425 is configured to move storage containers 106 back and forth along the second direction Y. The conveyors 425 of FIG. 12 have an extension in the second direction Y substantially equal to the footprint F_{VB} of the vehicle body 410. Alternatively, at least one of the conveyors 425 may extend outside the footprint F_{VB} of the vehicle body 410 in the second direction Yon at least one side.

Each conveyor 425 in FIG. 12 have a length in the second direction Y allowing three storage containers 106 to be supported simultaneously. At least the middle position is an accessing position P_{A}, while the positions on either side will typically be loading/offloading positions P_{L/O}. The conveyors 425 are configured to move a supported storage container 106 between the loading/offloading positions P_{L/O} and the accessing position P_{A}.

A picker support 430 is provided between the two conveyors 425. The picker support 430 is best suited for a robotic picking device 440, due to its short extent in the first direction X. This short extension still provides enough space for the robotic picking device 440, and at the same time it provides a short distance between the accessing positions P_{A} of the two conveyors, thus reducing the required radial gripper distance R_{G} of the robotic picking device 440.

The picker support 430 extends in the second direction Y substantially the same length as the conveyors 425. By making the robotic picking device 440 movable along the picker support 430, all positions of the conveyors 425 can be made accessing positions P_{A}. Alternatively, the radial gripper distance R_{G} of the robotic picking device 440 can be increased to make further positions of the conveyors 425 into accessing positions P_{A}.

If the picker support 430 was made wider in the first direction X it could be more suited for a human picker.

If a longitudinal side of the conveyor 425 is sufficiently close to the edge of the vehicle body 410, all positions on the conveyor 425 can be loading/offloading positions P_{L/O}. Something similar is illustrated in FIG. 14.

As an example, two container handling vehicles 301 can load and offload storage containers 106 at opposite ends of one of the conveyors 425. The first container handling vehicle 301 offloading a first storage container 106 already picked from, and the second container handling vehicle 301 loading a second storage container 106 to be picked from. In the position between the two storage containers 106 it is positioned a consolidation bin being picked to. The second storage container 106 is moved into the accessing position P_{A} by means of the conveyor 425. The robotic picking device 440 picks a product 80 from the second storage container 106 before it is moved back to the loading/offloading position P_{L/O}. The second container handling vehicle 301 offloads the second storage container 106, while a third container handling vehicle 301 loads a third storage container 106 to be picked from on the opposite loading/offloading position P_{L/O}. This cycle can then be repeated for as long as required.

As another example, the cycle described above can be executed on both conveyors 425 in FIG. 12. The robotic picking device 440 can then pick from a storage container 106 on the first conveyor 425 while storage containers 106 are loaded and offloaded on the second conveyor 425, and vice versa. In such case the robotic picking device 440 can pick products 80 from a storage container 106 supported by the first conveyor 425 and put that product 80 into a consolidation bin supported by the second conveyor 425. When the robotic picking device 425 later picks for a storage container 106 supported by the second conveyor 425, that product 80 can be put into a consolidation bin supported by the first conveyor 425 while storage containers 106 are loaded and offloaded at either end of the first conveyor 425.

As another example, storage containers 106 can be loaded at one end of the conveyor 425 and offloaded at the other end of the conveyor 425, i.e. the conveyor 425 does not move back and forth. When two conveyors 425 are used as illustrated in FIG. 12, the conveyors 425 can move in opposite directions. A first container handling vehicle 301 can then load a storage container 106 on the first conveyor 425 and then offload a second container 106 from the second conveyor 425 by moving one cell to the side. A second container handling vehicle 301 can perform the same operation on the opposite side of the remotely operated vehicle 400. The storage container magazine 470 may then preferably comprise a support for a consolidation bin, e.g. a fixed storage container support 427.

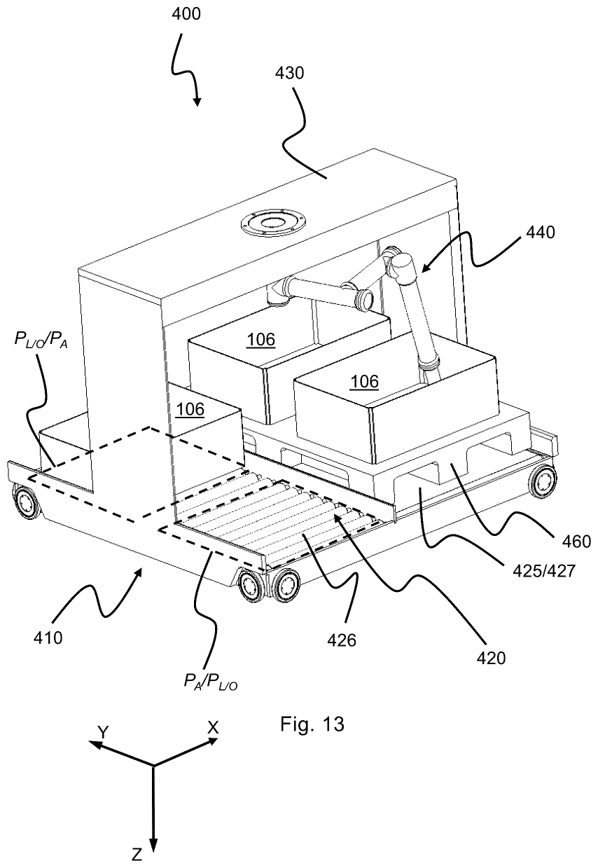

FIG. 13 is a perspective view of the remotely operated picking vehicle 400 wherein the storage container magazine 470 comprises two storage container handling devices 420, one in the form of rollers 426 and on in the form of a conveyor 425 or a fixed storage container support 427.

The rollers 426 can provide the same functionality as described for the conveyor 425. The rollers 426 may be configured for supporting two storage containers 106 as illustrated in FIG. 13. A longer roller 426 may obviously support a higher number of storage containers 106. The roller 426 provides at least one loading/offloading position P_{L/O} and at least one accessing position P_{A}. For rollers 426 configured to support two storage containers 106, the loading/offloading position P_{L/O} may also be the accessing position P_{A}, and vice versa.

The conveyor 425 or fixed storage container support 427 can be configured to support a pallet 460. This can be useful e.g. in cases where consolidation bins are to be transported on pallets 460 after picking. As an alternative to having consolidation bins on the pallet 460, storage containers 106 containing high demand products 80 can be placed on the pallet 460. Storage containers 106 containing high demand products 80 can also be placed directly on the storage container handling device 420 or fixed storage container support 427. Pallets 460 can be loaded and offloaded by means of a forklift or other pallet handling vehicles. If the conveyor 425 or the rollers 426 are configured to support a pallet 460, the pallet 460 may be loaded and offloaded by means of transferring to another conveyor or roller of an external unit.

FIG. 13 is thus an example of how different types of container handling vehicles 420 can be combined in the same storage container magazine 470.

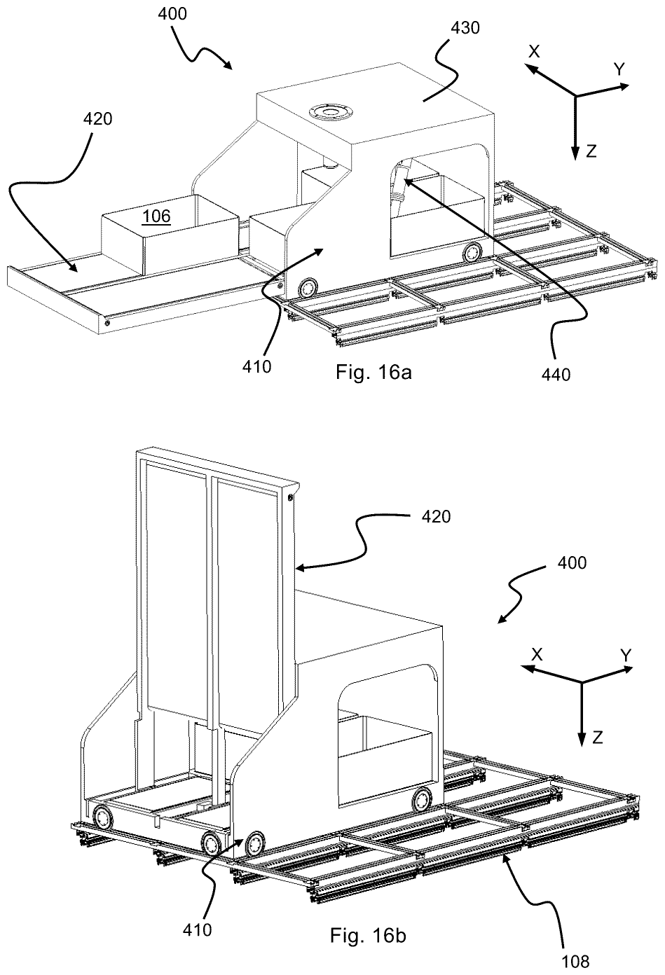

FIG. 13 further illustrates how the picker support 430 may have a portion that extends vertically above the storage container magazine 470. This is also illustrated in FIG. 14, FIG. 15, FIG. 16a and FIG. 16b.

The picker support 430 may be an arch, e.g. a flat arch as illustrated in FIG. 13. The robotic picking device 440 can then be arranged upside-down inside the arch as illustrated in FIG. 13 or alternatively on the vertical part of the arch. This enables the storage container handling devices 420 to be placed closer to each other, thus reducing the footprint of the vehicle body 410.

The picker support 430 in the form of an arc could be configured to move relative to the storage container magazine 470, thus extending the area suitable as accessing positions P_{A}.

FIG. 14 is a perspective view of the remotely operated picking vehicle 400 and a storage container handling vehicle 301 loading a storage container 106 on the loading/offloading position P_{L/O} of the storage container magazine 470.

FIG. 15 is a different perspective view of the remotely operated picking vehicle 400 of FIG. 14.

FIG. 14 and FIG. 15 illustrates a remotely operated picking vehicle 400 having a storage container magazine 470 comprising two conveyors 425 and a fixed storage container support 427. The fixed storage container support 427 is in this example configured to support two storage containers 106. Each conveyor 425 is in this example configured to support three storage containers 106. Instead of being loaded and unloaded at opposite ends, the conveyors 425 of FIG. 14 and FIG. 15 provides several loading/unloading positions P_{L/O} along the side. The conveyors 425 and the fixed storage container support 427 of FIG. 14 and FIG. 15 may have similar functionality as those of the previous figures.

FIG. 16a and FIG. 16b are perspective views of the same remotely operated picking vehicle 400. This remotely operated vehicle 400 has a storage container magazine 470 comprising two storage container handling devices 420 in the form of conveyors 425. The conveyors 425 are foldable and may thus be folded up as illustrated in FIG. 16b when not in use. The area occupied by the remotely operated picking vehicle 400 on the rail system 108 can thus be temporarily reduced. FIG. 16a show the conveyors 425 folded out to the position in which it can be used.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
80 Product
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art storage container vehicle
201a Vehicle body of the storage container vehicle 201
201b Drive means/wheel arrangement, first direction (X)
201c Drive means/wheel arrangement, second direction (Y)
301 Prior art cantilever storage container vehicle
301a Vehicle body of the storage container vehicle 301
301b Drive means in first direction (X)
301c Drive means in second direction (Y)
304 Gripping device
400 Remotely operated picking vehicle
410 Vehicle body
411 Base
412a First set of wheels
412b Second set of wheels
420 Storage container handling device
421 Rotational carousel device
422 Storage container support, of storage container handling device
423 Carousel arm
424 Hinged connection
425 Conveyor
426 Roller
427 Fixed storage container support, of storage container magazine
428 Rotatable shaft
430 Picker support
440 Robotic picking device
441 First robotic segment
442 Second robotic segment
443 Third robotic segment
444 Fourth robotic segment
445 Gripper
451 Camera
460 Pallet
470 Storage container magazine
500 Control system
X First direction
Y Second direction
Z Third direction
P_{H} Horizontal plane
W_{f} Width of storage container
L_{f} Length of storage container
H_{f} Height of storage container
A_{f} Areal of storage container
R_{C} Radial carousel distance
C_{C} Rotational axis of the rotational carousel device
C_{RV} Vertical rotational axis of the first robotic segment/vertical section
C_{RR} Radial rotational axis of the second robotic segment
R_{G} Radial gripper distance
P_{A} Storage container accessing position
P_{L/O} Storage container loading/offloading position
F_{VB} Footprint of the vehicle body

1. A remotely operated picking vehicle for an automated storage and retrieval system for retrieving and storing products within storage containers, wherein the remotely operated picking vehicle comprises:
a vehicle body comprising a base with displacement means for transportation on a rail system;
a picker support for a robotic picking device or a human picker, the picker support being arranged on the vehicle body;
a storage container magazine for supporting three or more storage containers simultaneously, the storage container magazine being arranged on the vehicle body and comprising:
a storage container loading/offloading position for loading and offloading of storage containers by means of a container handling vehicle; and
a storage container accessing position for presenting storage containers to a picker positioned on the picker support.

2. The remotely operated picking vehicle according to claim 1,
wherein the displacement means comprises:
a first set of wheels, arranged on opposite sides of the base, for moving the remotely operated picking vehicle along a first horizontal direction on the rail system; and
a second set of wheels, arranged on other opposite sides of the base, for moving the remotely operated picking vehicle along a second horizontal direction on the rail system, the second direction being perpendicular to the first direction.

3. The remotely operated picking vehicle according to claim 1,
wherein the displacement means comprises:
a set of continuous tracks, arranged on opposite sides of the base, for moving the remotely operated picking vehicle on the rail system.

4. The remotely operated picking vehicle according to claim 1,
wherein the storage container magazine comprises at least one container handling device configured for movement of a storage container at least from a storage container loading/offloading position to a storage container accessing position.

5. The remotely operated picking vehicle according to claim 4, wherein the storage container handling device is configured to be in signal communication with a control system.

6. The remotely operated picking vehicle according to claim 4, wherein the storage container magazine comprises:
a plurality of storage container handling devices arranged adjacent the picker support.

7. The remotely operated picking vehicle according to claim 1, wherein the picker support is configured for horizontal movement of the robotic picking device or the human picker.

8. The remotely operated picking vehicle according to claim 1, wherein the vehicle body has a footprint and the storage container accessing position is horizontally arranged inside the footprint.

9. The remotely operated picking vehicle according to claim 1,
wherein the remotely operated picking vehicle comprises a plurality of storage container loading/offloading positions.

10. The remotely operated picking vehicle according to claim 1,
wherein the remotely operated picking vehicle comprises a plurality of storage container accessing positions.

11. The remotely operated picking vehicle (400) according to claim 1,
wherein the storage container handling device comprises:
a rotational carousel device having a rotational axis; and
a plurality of storage container supports connected to the rotational carousel device, allowing rotation of the storage container supports through at least a storage container loading/offloading position and a storage container accessing position.

12. The remotely operated picking vehicle according to claim 11,
wherein the storage container handling device further comprises:
a carousel arm extending radially from a central portion of the rotational carousel device; and
a carousel motor configured to rotate the carousel arm around the vertical rotational axis;
wherein the storage container support is arranged at an end of the carousel arm distal to the vertical rotational axis.

13. The remotely operated picking vehicle according to claim 12,
wherein the carousel arm has hinged connections to the container support and to the rotational carousel device.

14. The remotely operated picking vehicle according to claim 1, wherein the storage container handling device comprises:
a conveyor or rollers for horizontal movement of a storage container through at least the storage container loading/offloading position and the storage container accessing position.

15. The remotely operated picking vehicle according to claim 1,
wherein the storage container magazine comprises a fixed storage container support.

16. The remotely operated picking vehicle according to claim 1,
wherein the picker support has a portion that extends vertically above the storage container magazine.

17. The remotely operated picking vehicle according to claim 1,
wherein the remotely operated vehicle further comprises:
a robotic picking device, wherein the robotic picking device comprises:
a first robotic segment connected to the vehicle body; and
a gripper connected at least indirectly to the first robotic segment, the gripper being spaced at an adjustable radial gripper distance between the first robotic segment and the gripper such that the gripper is at least within reach of the storage container accessing position,
wherein the gripper is configured to releasably grab a product from within a storage container positioned in the storage container accessing position; and
wherein the robotic picking device is configured to be in signal communication with a control system.

18. The remotely operated picking vehicle according to claim 17,
wherein the first robotic segment is rotatably connected to the vehicle body with a first rotational axis.

19. The remotely operated picking vehicle according to claim 18,
wherein the robotic picking device further comprises:
a second robotic segment rotatably connected to the first robotic segment, wherein a longitudinal orientation of the second robotic segment is adjustable relative to the first rotational axis.

20. The remotely operated picking vehicle according to claim 19,
wherein the second robotic segment comprises:
a first end rotatably connected to the first robotic segment; and
wherein the robotic picking device further comprises:
a third robotic segment comprising a first end rotatably connected to a second end of the second robotic segment and a second end at least indirectly connected to the gripper.

21. The remotely operated picking vehicle according to claim 17, wherein the robotic picking device has a radial gripper distance extending outside the footprint of the vehicle body, wherein the gripper is configured to releasably grab a product from within a storage container positioned below the rail system.

22. The remotely operated picking vehicle according to claim 1, wherein the remotely operated picking vehicle further comprises:
a camera system, the camera system comprising:
a camera configured to visually inspect products within a storage container positioned in, or approaching, the storage container accessing position; and
a camera transmitter configured to transmit information from the visual inspection of the contents to the control system.

23. An automated storage and retrieval system, wherein the automated storage and retrieval system comprises:
a remotely operated picking vehicle according to claim 1;
a rail system comprising a first set of parallel rails arranged in a horizontal plane and extending in a first direction and a second set of parallel rails arranged in the horizontal plane and extending in a second direction which is orthogonal to the first direction, which first and second sets of rails form a grid pattern in the horizontal plane comprising a plurality of adjacent grid cells, each comprising a grid opening defined by a pair of neighbouring rails of the first set of rails and a pair of neighbouring rails of the second set of rails;
a plurality of stacks of storage containers arranged in storage columns located beneath a storage section of the rail system, wherein each storage column is located vertically below a grid opening; and
a container handling vehicle comprising a lifting device for lifting storage containers stacked in the stacks above the storage section and drive means configured to drive the container handling vehicle along the rail system in at least one of the first direction and the second direction.

24. A method of handling products within storage containers stored in an automated storage and retrieval system according to claim 22, wherein the method comprises:
placing a storage container in a storage container magazine of a remotely operated picking vehicle by means of a storage container handling vehicle;
picking a product from the storage container by means of a robotic picking device or a human picker;
retrieving the storage container from the storage container magazine by means of the storage container handling vehicle.

25. The method according to claim 24,
wherein the remotely operated picking vehicle comprises at least one storage container handling device; and
wherein the storage container accessing position has a different location than the storage container loading/offloading position-,
wherein the method further comprises:
before a product is picked, moving the storage container from the storage container loading/offloading position to a storage container accessing position by means of a storage container handling device; and
after a product is picked, moving the storage container from the storage container accessing position to the storage container loading/offloading position by means of the storage container handling device.

26. The method according to claim 24,
wherein the method further comprises:
placing the picked product in a consolidation bin supported by the storage container handling device.

27. The method according to claim 24,
wherein the method further comprises:
moving the remotely operated picking vehicle along the rail system in a direction of a target storage container.

28. The method according to claim 24,
wherein the remotely operated picking vehicle comprises a plurality of loading/offloading positions,
wherein the method further comprises:
while retrieving one storage container from a first storage container loading/offloading position by means of a first storage container handling vehicle, providing another storage container at a second storage container loading/offloading position by means of a second storage container handling vehicle.

29. The method according to claim 24,
wherein the remotely operated picking vehicle comprises a plurality of storage container accessing positions,
wherein the method further comprises:
with a first storage container positioned in a first storage container accessing position,
providing a second storage container in a second storage container accessing position.
